(19) United States
(12) Patent Application Publication
(10) Pub. No.: US 2009/0259998 A1
(43) Pub. Date: Oct. 15, 2009

(54) METHOD, SYSTEM AND COMPUTER PROGRAM FOR IDENTIFYING AND REUSING COMPONENT AGGREGATES

(75) Inventors: Lawrence Bergman, Mount Kisco, NY (US); Ravi B. Konuru, Tarrytown, NY (US); Richard D. Thompson, Trumbull, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/101,483

(22) Filed: Apr. 11, 2008

(51) Int. Cl. G06F 9/45

(52) U.S. Cl. 717/154

(57) ABSTRACT

A method of automatically identifying entity aggregates for use in creating entity libraries is provided. The method includes: identifying one or more sub-entities of a first application; identifying one or more sub-entities of a second application; determining common usage patterns between the one or more sub-entities of the first application and the one or more sub-entities of the second application; and generating one or more entity aggregates based on the common usage patterns.

### BACKGROUND

1. Field

This invention relates to automating the association of common entities, and particularly to automating the association of common entities for use in distributing libraries of the entities.

2. Description of Background

A widget, in terms of graphical user interfaces, is a combination of a graphical symbol and the associated programming code. A widget toolkit or widget library includes a set of widgets for use in designing a graphical user interface. Suppliers of these toolkits or libraries make “best guesses” as to what will be useful to consumers/developers. Based on the “best guesses” the suppliers package and license the libraries.

It is only through experience and the collection of customer feedback that the suppliers can make these “best guesses.” This process is most commonly performed in an ad-hoc fashion. This process can be time consuming and may not always produce the best results.

### SUMMARY

The shortcomings of the prior art are overcome and additional advantages are provided through the provision of a method of automatically identifying entity aggregates for use in creating entity libraries. The method includes: identifying one or more sub-entities of a first application; identifying one or more sub-entities of a second application; determining common usage patterns between the one or more sub-entities of the first application and the one or more sub-entities of the second application; and generating one or more entity aggregates based on the common usage patterns.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, improved component aggregates are provided to developers. The improvement to the component aggregates: reduces the skill needed to develop a useful collection of entities by incorporating the usage statistics to help guide the selection and inter-connection of aggregates; reduces the developer effort to seek out opportunities for entity aggregation; and provides assurance to the developer that the entity aggregates are based on real usage patterns, by way of statistics presented with the candidates to assess how widely each aggregate is used in practice.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings.

FIG. 1 is a block diagram illustrating a computing system that includes a component aggregate identification system in accordance with an exemplary embodiment.

FIG. 2 is a block diagram illustrating the component aggregate identification system in accordance with an exemplary embodiment.

FIG. 3 is a bock diagram illustrating an association set extractor of the component aggregate identification system in accordance with an exemplary embodiment.

FIG. 4 is a block diagram illustrating a recommendation extractor of the component aggregate identification system in accordance with an exemplary embodiment.

FIG. 5 is a flowchart illustrating an association set extraction method that can be performed by the association set extractor of FIG. 3 in accordance with an exemplary embodiment.

FIG. 6 is flowchart illustrating a recommendation extraction method that can be performed by the recommendation extractor of FIG. 4 in accordance with an exemplary embodiment.

The detailed description explains the preferred embodiments of the invention, together with advantages and features, by way of example with reference to the drawings.

### DETAILED DESCRIPTION

An exemplary embodiment of the present invention provides an automated system for generating recommendations of an aggregate of common entities. The automated system generates the recommendations based on actual usage of the entities. In one example, the automated system generates the recommendations based on a co-occurrence of the common entities in multiple applications.

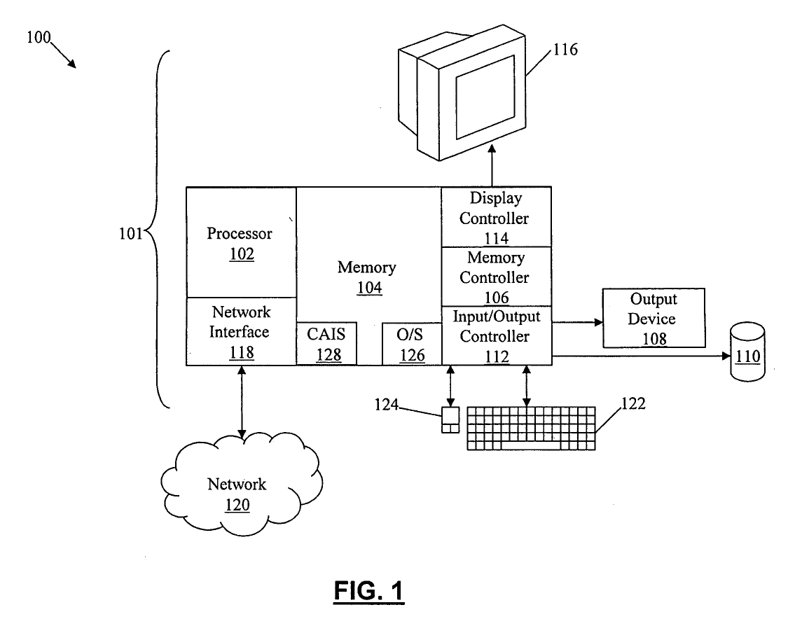

Turning now to FIG. 1, a block diagram illustrates an exemplary computing system 100 that includes a component aggregate identification system in accordance with the present disclosure. The computing system 100 is shown to include a computer 101. As can be appreciated, the computing system 100 can include any computing device, including but not limited to, a desktop computer, a laptop, a server, a portable handheld device, or any other electronic device. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, the system 100 can further include a network interface 118 for coupling to a network 120. The network 120 transmits and receives data between the computer 101 and external systems. In an exemplary embodiment, a conventional keyboard 122 and mouse 124 can be coupled to the input/output controller 112.

In various embodiments, the memory 104 stores instructions that can be executed by the processor 102. The instructions stored in memory 104 may include one or more separate programs, each of which comprises an ordered listing of executable instructions for implementing logical functions. In the example of FIG. 1, the instructions stored in the memory 104 include at least a suitable operating system (OS) 126. The operating system 126 essentially controls the execution of other computer programs and provides scheduling, input-output control, file and data management, memory management, and communication control and related services.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The processor 102 executes the instructions of the component aggregate identification system of the present disclosure. In various embodiments, the component aggregate identification system 128 of the present disclosure is stored in the memory 104 (as shown), is executed from a portable storage device (e.g., CD-ROM, Diskette, FlashDrive, etc.) (not shown), and/or is run from a remote location such as from a central server (not shown).

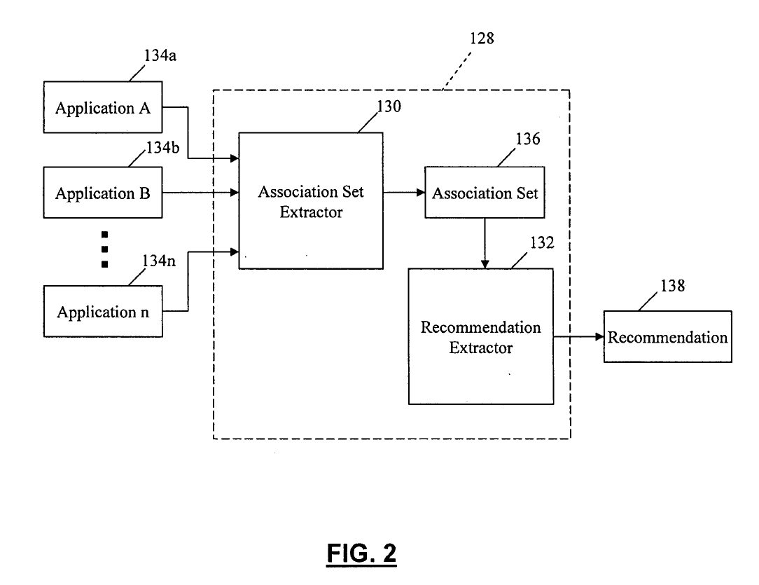

As shown in FIG. 2, the component aggregate identification system 128 includes an association set extractor 130 and a recommendation extractor 132. Generally speaking, the association set extractor 130 evaluates various applications 134a-134n and generates a listing of associated elements within the various applications, hereinafter referred to as an association set 136. The recommendation extractor 132 generates a recommendation 138 of aggregate elements based on the association set 136.

In one example, the applications 134a-134n are any composite software-based entities, for example, web pages, or application user interfaces (UIs). In this case, the recommendation can be used by a developer to select or purchase an appropriate library for future developments. As can be appreciated, the applications can be any software, hardware, or service that is defined by one or more sub-entities.

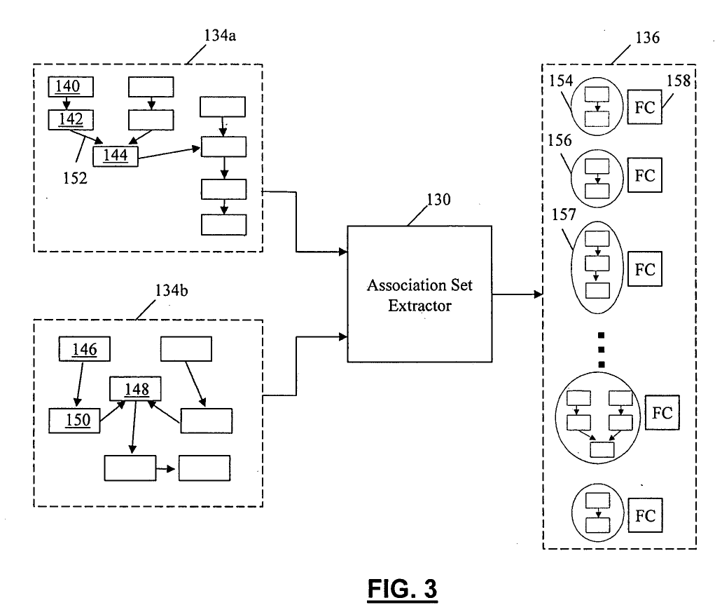

Turning now to FIG. 3, the association set extractor 130 of FIG. 2 will be discussed in more detail in accordance with various aspects of the present disclosure. As shown, the applications 134a, 134b each include one or more components 140-144, 146-150. The components 140-144, 146-150 can be any sub-entity, for example, a module, a portlet, or a widget. In various embodiments, the components 140-144, 146-150 can be associated by one or more connections 152. The connections 152 may or may not exist, and can represent logical connections, data flows, caller-callee relationships, ontological connections, etc.

The association set extractor 130 generates the association set 136 by identifying one or more set elements 154, 156. Each set element 154, 156 includes one or more components 140-150. The association set extractor 130 identifies the set elements 154, 156 based on a common co-occurrence of the components 140-144, 146-150 within the applications 134a, 134b. For example, the component 140 in application 134a can have an identical counterpart component 146 in application 134b. Similarly, component 142 can have a counterpart component 150 in application 134b. The association set extractor 130 associates component 140 with component 146, and component 142 with component 150 and extracts the association set 154. The association set 154 contains the two components. Although this example includes connections 152 between the components 140-150, the connections 152 need not be taken into account by the association set extractor 130 in the association and extraction process.

In various embodiments, the set elements 154, 156 within the association set 136 may be extracted based on exact match as described above. In various other embodiments, the set elements 154, 156 may be extracted based on some similarity metric. For example, the components may be related where an application containing the components (A₁, B₁) and another application containing the components (A₂, B₂) where A1 is similar to A₂ and B₁ is similar to B₂. As can be appreciated, the similarity metric can be based on any number of factors, including, but not limited to, name identity, complete or partial metadata match, and structural similarity. When the similarity metric is used, the set element 154, 156 may contain all instances of the component or, alternatively the set element 154, 156 may be represented using distinct records for each instance, using parameterizations, or using other techniques.

In various embodiments, the set elements 154, 156 need not contain information from all available applications. Consider, for example, a case where three applications are available, application A, application B, and application C. It may be the case that one particular set element 154 or 156 contains the components (U, V) which are found in both applications A and B and not in application C. Another set element 154 or 156 may contain components (X, Y), which are found in applications B and C, but not in application A. These “partial matches” are accounted for by maintaining a frequency count 158 for each set element 154, 156. The frequency count 158 records the number of applications 134a, 134b, which contain the components 140-150 enumerated in the set element 154, 156.

In various embodiments, some set elements may be proper subsets of other set elements. For example, the set element 154 includes all the components 140-150 contained within set element 157. This allows the recommendation extractor 132 (FIG. 2) to consider aggregates at a variety of scales, not simply the largest (or smallest) possible.

In various embodiments, a variety of information can be employed to further refine the determination of co-occurrences of the components 140-150. For example, the association set extractor 130 can track whether or not the components 140-150 are wired together, whether they have uses that are complementary (perhaps employing tags or metadata to make that determination), runtime behavior (e.g., whether entities have a temporal sequencing to their activation), and/or other information.

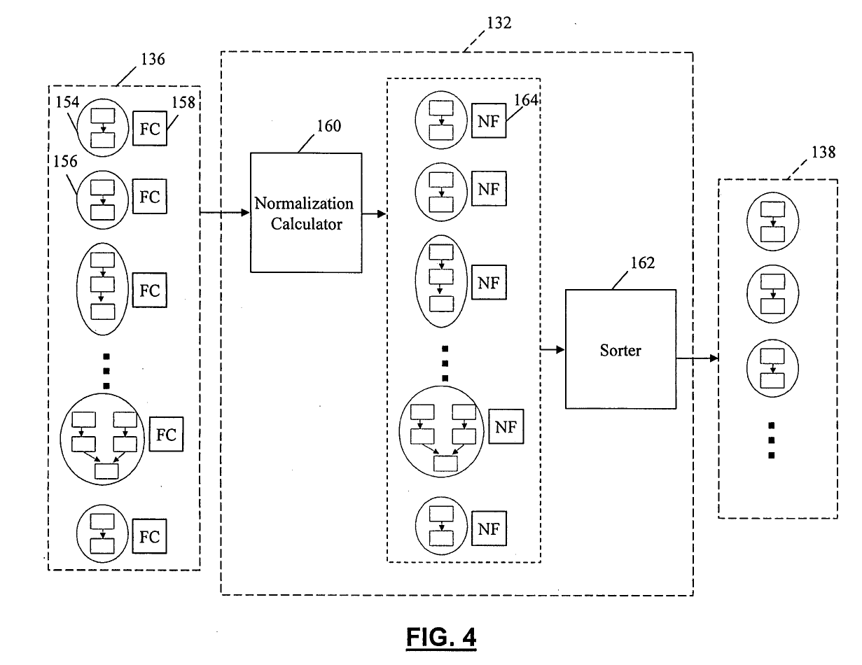

Turning now to FIG. 4, the recommendation extractor 132 of FIG. 2 will be discussed in more detail in accordance with various aspects of the present disclosure. The recommendation extractor 132 includes a normalization calculator 160 and a sorter 162. As shown, the recommendation 138 is generated based on the association set 136. In one example, the normalization calculator 160 normalizes each frequency count 158 within the association set 136 by dividing each frequency count 158 by a total number of applications. As can be appreciated, more than two applications can be assumed to provide a wider range of possible normalized frequencies. If only two applications are used, the only possible normalized value would be 1.0.

The sorter 162 uses the normalized frequencies 164, along with other available information including, but not limited to, a number of components, component identity, and relationship between identities to rank the set elements 154, 156. In one example, the sorter 162 ranks the set element 154, 156 with the highest normalized frequency first in the recommendation 138. Similarly, the set element 154, 156 with the second highest normalized frequency is ranked second in the recommendation 138, and so on.

In various embodiments, in addition to ranking the set elements 154, 156, the sorter 162 can also filter the set elements 154, 156, using any of the criteria used for ranking, and/or other criteria.

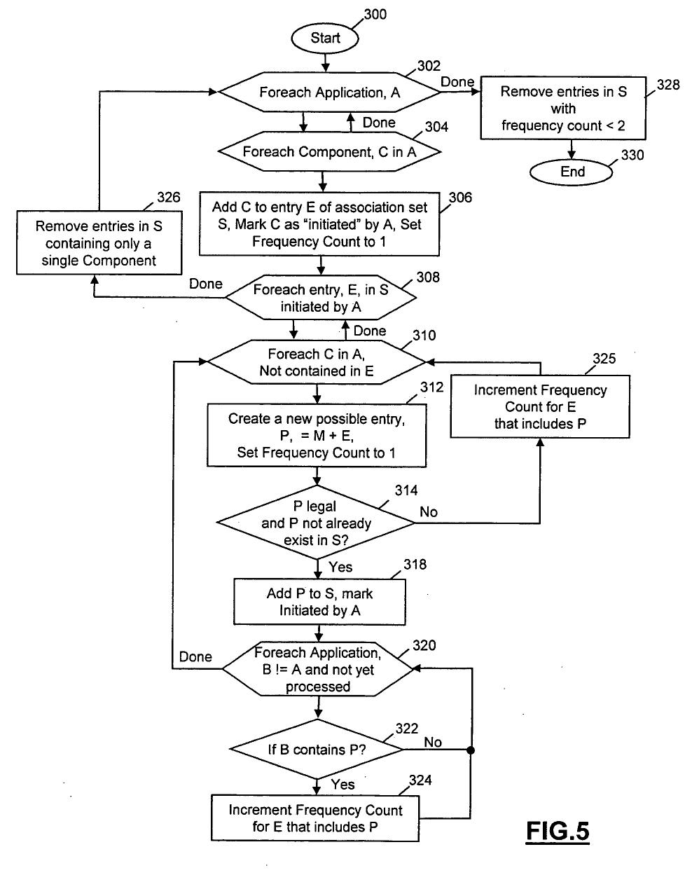

Turning now to FIG. 5, a flowchart illustrates an association set identification method that can be performed by the association set extractor 130 of FIG. 2 in accordance with various aspects of the present disclosure. As can be appreciated in light of the disclosure, the order of operation within the method is not limited to the sequential execution as illustrated in FIG. 5, but may be performed in one or more varying orders as applicable and in accordance with the present disclosure.

In one example, the method begins at block 300. The method iterates for each application of the application set. At block 302, each application is selected and assigned to a variable (A), for example. For each component (C) in A at block 304, an entry (E) is created in the association set (S). The entry includes that component, a frequency count initialized to one, and an indication that the component is “initiated” by application. An alternative would be to keep a separate data structure for these new entries, and add appropriate entries from the data structure to S as part of the end-of-application loop processing.

These initiated entries are then iterated on at block 308. For each entry (E) at block 308, all the components in A that are not contained in E are processed at block 310. Each such component is used to create a new possible entry (P) that includes C plus E, and a frequency count initialized to one at block 312. Note that P is not inserted into S at this time. In particular, P includes the contents of E with the component C added to it. If connections are being considered as part of the aggregate extraction process, then any connections between C and the components stored in P are retained. In this case, P would store a graph structure using any of the well-known methods for storing graphs.

At block 314, P is then checked for legality and whether the configuration is already contained within S. The meaning of “legal” will vary depending on what is considered an appropriate aggregate. For example, if a requirement exists that all components be connected within an aggregate, and M is not connected to any of the components contained within E, then P would not be considered legal. As can be appreciated, any one of a variety of indexing schemes known in the art can be used to facilitate the check of whether the configuration is already contained within S.

If P is legal and not contained within S at block 314, then P is added to S and marked as initiated by A at block 318. At block 320, all applications other than A that have not yet been processed are iterated on at block 320, with B assigned to the other application. If B contains a subset of components that correspond to P at block 322, then the frequency counter for P is incremented at block 324. Otherwise, the method continues to iterate on all applications B not equal to A. Note that correspondence may be based only on containing the same set of components, on whether the set of components is similarly connected, or on other similarity metrics.

If, at block 314, P is not legal or already exists in S, the frequency counter is incremented at block 324 and the method continues to iterate for all components in A not contained in E at block 310.

When all entries in S that are initiated by A have been processed at block 308, any entries in S that contain only a single component are removed at block 326. (In the case of using a separate data structure, these entries are removed from that data structure, and then the contents of the data structure are added to S).

When all applications have been processed, any entries that have a frequency count less than two are removed from S at block 328. Thereafter, the method may end at block 330.

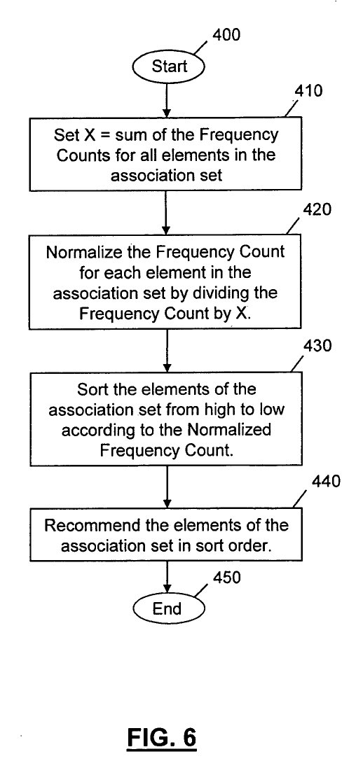

Turning now to FIG. 6, a flowchart illustrates an aggregate recommendation generation method that can be performed by the recommendation extractor 132 of FIG. 2 in accordance with various aspects of the present disclosure. As can be appreciated in light of the disclosure, the order of operation within the method is not limited to the sequential execution as illustrated in FIG. 6, but may be performed in one or more varying orders as applicable and in accordance with the present disclosure.

In one example, the method may begin at block 400. A sum (X), of the frequency counts for all elements in the association set (S) is accumulated at block 410. The sum is then used to normalize the frequency counts (FC) for each set element (E) in the association set, by dividing the frequency count for each set element by the sum at block 420. The set elements are then sorted from high to low according to the normalized frequency count (NC) at block 430. The set elements are presented to a user in sort order as recommendations for aggregation at block 440. Thereafter, the method may end at block 450.

As can be appreciated, the aggregate recommendation generation method can be based on different ranking schemes and/or filtering schemes. The ranking schemes and/or filtering schemes can be based on other attributes of the set elements, relationships between the set elements, and/or other metrics associated with the set elements. For example, the recommendation can include only the largest possible aggregations. In that case, the aggregate recommendation generation method detects set elements that are subsets of other set elements, and eliminates the subsets (process not shown).

As can be appreciated, the capabilities of the present invention can be implemented in software, firmware, hardware or some combination thereof.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method of automatically identifying entity aggregates for use in creating entity libraries, the method comprising:
providing a computer readable medium bearing software instructions that enable a computer to perform predetermined operations, the operations include the steps of:
identifying one or more sub-entities of a first software application;
identifying one or more sub-entities of a second software application;
determining common usage patterns between the one or more sub-entities of the first software application and the one or more sub-entities of the second software application
generating one or more entity aggregates based on the common usage patterns; and
providing a recommendation based on the one or more entity aggregates.

2. (canceled)

3. The method of claim 2 wherein the providing a recommendation is based on at least one of a sorting and a ranking of sub-entities of the one or more entity aggregates.

4. The method of claim 1 wherein the determining the common usage patterns is based on a co-occurrence of sub-entities within the first software application and the second software application.

5. The method of claim 1 wherein the operations further comprise:
estimating a frequency count for each sub-entity; and
computing a normalization of each frequency count,
wherein the generating the entity aggregate is based on the normalization of each frequency count.
